(19) United States
(12) Patent Application Publication
(10) Pub. No.: US 2007/0292238 A1
(43) Pub. Date: Dec. 20, 2007

(54) THREAD FORMING WIRE THREAD INSERT

(76) Inventors: Simon James Bowen, Vermont (AU); Peter Venetis, Melbourne (AU)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/548,224

(22) Filed: Oct. 10, 2006

(30) Foreign Application Priority Data
Jun. 19, 2006 (AU) 2006903285

(51) Int. Cl. F16B 37/12

(52) U.S. Cl. 411/438

(57) ABSTRACT

A wire thread insert (1) for forming a helical thread, comprising a wire (7) wound into a closed coil having an outer surface (9) and an inner surface (11), wherein the wire (7) has a first portion (13) defining the inner surface of the thread insert when coiled, said first portion having a cross-section at least substantially in the form of a standard thread, the wire having an opposing second portion (15) defining the outer surface of the thread insert and having a cross-section in the form of a tapered flange with at least one concave face (23).

### RELATED APPLICATIONS

This application claims the benefit of and priority to Australian Provisional Application No. 2006903285, filed on Jun. 19, 2006, the contents of which are incorporated by reference herein in its entirety.

### FIELD OF THE INVENTION

The present invention is directed to wire thread inserts used in the repair of pre-existing threaded bores having a damaged thread, or to form a new thread for a bore within a substrate.

### BACKGROUND OF THE INVENTION

Wire thread inserts are conventionally provided by wrapping a wire into a closed coil configuration, the coiled insert having an inner and outer surface. The cross-section of the wire has a diamond shape and is coiled such that one portion of the coiled wire provides an inner helical thread for the inner surface of the insert, while the other portion of the coiled wire provides a second helical thread for the outer surface of the insert which is adapted to engage a helical thread provided in a bore within a substrate.

These wire thread inserts are typically used to repair threaded bores where the thread has been damaged or stripped. They can also be used to provide a new thread for a bore.

The normal procedure for repairing an existing threaded bore and for installing such a wire thread insert is as follows:

a) passing a drill bit through the bore to clean out and remove the remaining sections of the original helical thread;

b) using a tap to provide a new helical thread within the drilled bore, this helical thread having a diameter greater than the original helical thread of the bore;

c) inserting the wire thread insert by means of an installation tool which engages a tang of notch on the inner surface provided at the end of the insert and applying a torsional force to the insert to thereby twist and temporarily narrow the diameter of the insert thereby allowing the insert to enter and engage the female helical thread in that bore;

d) releasing the insert such that it springs outwardly again to more tightly engaging the threaded bore; and

e) finally breaking or twisting off the tang when and if provided at the end of the wire thread insert.

The torsional force applied to the sire thread insert initially twists and thereby compresses that insert such that it can be readily wound into the helical thread. Once the torsional force is removed from the thread insert, that insert expands outwardly to secure the engage the female helical thread provided within the threaded bore. This ensures that the thread insert remains securely in place when a bolt is subsequently inserted and engages the new female helical thread provided by the inside surface of that thread insert. A similar procedure is followed where the insert is being used to provide a new helical thread within a bore.

A number of steps are therefore required to install the wire thread insert. It would however be advantageous to provide a wire thread insert which eliminates some of the above-noted installation steps thereby reducing installation and tooling costs.

### SUMMARY OF THE INVENTION

It is therefore an object of the present invention to provide a wire thread insert that does not require all the installation steps associated with conventional wire thread inserts.

With this in mind, the present invention provides a wire thread insert for forming a helical thread, comprising a wire wound into a closed coil having an outer surface and an inner surface,

wherein the wire has a first portion defining the inner surface of the thread insert when coiled, said first portion having a cross-section at least substantially in the form of a standard thread, the wire having an opposing second portion defining the outer surface of the thread insert and having a cross section in the form of a tapered flange with at least one concave face.

Preferably, the cross-section of the tapered flange is provided with opposing concave faces.

The cross-section of the tapered flange of the wire includes a base forming the junction between the first and second portions of the wire. The length of the tapered flange measured from the free end of the tapered flange to said base may be directly proportional to the modulus of elasticity of the substrate material in which the insert is adapted to be installed. The profile of the concave walls of the second side of the wire may be generally defined by the “rule of thirds”, such that the thickness of the tapered flange measured in the pitch dimension (i.e. parallel to the base) varies as a function of the distance away from the free end of the tapered flange in a 3:1 ratio.

The wire thread insert may be made of material including stainless steel or other metal. The substrate materials may include but not be limited to polymers, non-ferrous alloys and ferrous alloys.

The profile of the tapered flange portion of the wire allows the wire insert to be inserted into a bore within a substrate, the profile of the tapered flange being adapted to plastically deform the material of said substrate as the wire thread insert is wound into the bore. The tapered flange therefore forms a thread within the substrate material as the insert is installed. It should be noted that the thread is not being cut into the substrate material. The substrate material is in fact plastically deforming around the tapered flange.

### BRIEF DESCRIPTION OF THE DRAWINGS

It will be convenient to further describe the invention with respect to the accompanying drawings which illustrate a preferred embodiment of the wire thread insert according to the present invention. Other embodiments of the invention are possible, and consequently, the particularly of the accompanying drawings is not to be understood as superseding the generality of the preceding description of the invention.

In the drawings:

FIG. 1 is a side cross-sectional view of a wire thread insert according to the present invention installed within a bore; and

FIG. 2 is a detailed view designated “A” in FIG. 1.

### DETAILED DESCRIPTION

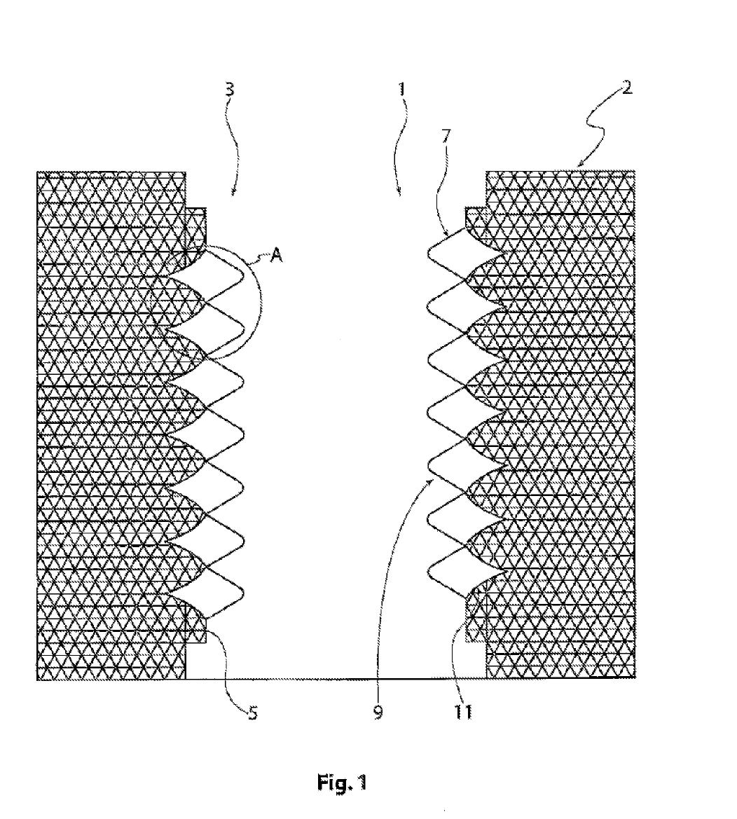

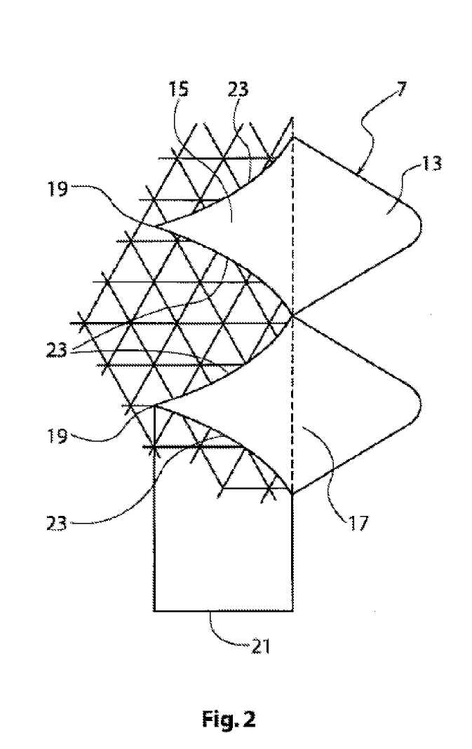

Referring to FIGS. 1 and 2, the thread forming wire thread insert 1 according to the present invention can be inserted into a bore 3 provided within a substrate 2. The bore 3 may be drilled into the substrate 2 or may be integrally formed together with the substrate 2 or may be integrally formed together with the substrate 2 prior to insertion of the wire thread insert 1, the internal walls 5 are relatively smooth without the need for any helical thread to be provided within the bore 3.

The wire thread insert 1 is installed into the bore 3 by means of an installation tool (not shown) which has a mandrel which allows the setting and maintaining of the thread pitch of the wire thread insert 1 during installation thereof. The mandrel dimensions are designed to maintain the gauge dimensions of the installed wire thread insert 1, and this may vary from a standard thread hole wire thread insert.

The wire thread insert 1 is formed by wrapping a wire 7 into a closed coil having an inner surface 9 providing an internal helical thread, and an outer surface 11 which provides the thread forming arrangement according to the present invention. The wire has a first portion 13 forming the inner surface 9 of the wire thread insert 1, and a second portion 15 forming the outer surface 11 thereof. The first portion 13 is in the form of a standard thread and is adapted to cooperate with the thread of a bolt or other threaded fastener. The second portion 15 has a cross-section in the shape of a tapered flange which extends from a base 17 defined by the interface between the first and second portions 13, 15 to a tip 19 of the tapered flange 25. The length 21 of the tapered flange 25 measured between the base 17 and tip 19 is directly proportional to the modulus of elasticity of the substrate 2 to which it is to be used increases. Each tapered flange 25 has opposing flat concave faces 23 as best shown by FIG. 2. The shape of the cross-section of the tapered flange 25, and therefore the curvature of the concave faces 23, is determined by on the basis of the “rule of thirds”. More specifically, the thickness of the tapered flange 25 measured in a pitch dimension (i.e. parallel to the base 17) varies as a function of the distance from the tip 19 in a 3:1 ratio.

The configuration of the tapered flange 25 allows the substrate material to plastically deform about the tapered flange 25 as the wire thread insert 1 is installed into the bore 3 without the need to pre-machine a helical thread within that bore.

Modifications and variations as would be deemed obvious to the person skilled in the art are included within the ambit of the present invention as claimed in the appended claims.

1. A wire thread insert for forming a helical thread, comprising a wire wound into a closed coil having an outer surface and an inner surface,
wherein the wire has a first portion defining an inner surface of the thread insert when coiled, said first portion having a cross-section at least substantially in the form of a standard thread, the wire having an opposing second portion defining the outer surface of the thread insert and having a cross-section in the form of a tapered flange with at least one concave face.

2. A wire thread insert according to claim 1, wherein the cross-section of the tapered flange is provided with opposing concave faces.

3. A wire thread insert according to claim 2, wherein the thickness of the tapered flange measured in a pitch dimension varies as a function of the distance away from a free end of the tapered flange in a 3:1 ratio.
